(19) United States
(12) Patent Application Publication
(10) Pub. No.: US 2024/0144443 A1
(43) Pub. Date: May 2, 2024

(54) Automatic Text Legibility Improvement within Graphic Designs

(71) Applicant: Microsoft Technology Licensing, LLC, Redmond, WA (US)

(72) Inventors: Mrinal Kumar SHARMA, Noida (IN); Atul SINGH, Noida (IN); Cheshtha SINDHWANI, Noida (IN)

(73) Assignee: Microsoft Technology Licensing, LLC, Redmond, WA (US)

(21) Appl. No.: 18/050,197

(22) Filed: Oct. 27, 2022

(51) Int. Cl. G06T 5/00; G06T 11/60

(52) U.S. Cl. CPC G06T 5/002; G06T 11/60; G06T 2200/24; G06T 2210/12

(57) ABSTRACT

A method for automatically improving the legibility of text within graphic designs is implemented via a computing system including a processor. The method includes executing a graphics application and causing surfacing of a graphic design GUI on a display. The method includes generating a templatized image including text responsive to the user-initiated insertion of a desired image into a design template surfaced via the graphic design GUI. The method also includes assigning a legibility score to the text within the templatized image and, responsive to a determination that the legibility score is less than a predetermined threshold, generating a bounding box around the text area. The method further includes generating an improved templatized image with improved text legibility by selectively blurring the image portion that falls within the bounding box, as well as causing surfacing of the second templatized image via the graphic design GUI.

### BACKGROUND

The present disclosure relates to computerized graphic design using graphics applications. In particular, the present disclosure relates to the automatic improvement of the legibility of text within graphic designs that are created using graphics applications.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a method for automatically improving the legibility of text within a graphic design is described. The method is implemented in a computing system including a processor. The method includes executing, via a network, a graphics application on a remote computing system and causing the surfacing of a graphic design graphical user interface (GUI) on a display of the remote computing system during the execution of the graphics application. The method also includes, responsive to the user-initiated insertion of a desired image into a design template surfaced via the graphic design GUI, generating a first templatized image including text and assigning a legibility score to the text within the first templatized image. The method further includes, responsive to a determination that the legibility score is less than a predetermined threshold, generating a bounding box around a text area of the first templatized image, generating a second templatized image with improved text legibility by selectively blurring a portion of the first templatized image that falls within the bounding box, and causing the surfacing of the second templatized image via the graphic design GUI.

In another embodiment, a server is described. The server includes a processor, a graphics application with integrated text support, a communication connection for connecting a remote computing system to the server via a network, and a computer-readable storage medium operatively coupled to the processor. The computer-readable storage medium includes computer-executable instructions that, when executed by the processor, cause the processor to execute, via the network, the graphics application on the remote computing system and cause the surfacing of a graphic design GUI on a display of the remote computing system during the execution of the graphics application. The computer-readable storage medium also includes computer-executable instructions that, when executed by the processor, cause the processor to, responsive to a user-initiated insertion of a desired image into a design template surfaced via the graphic design GUI, generate a first templatized image including text, and assign a legibility score to the text within the first templatized image. The computer-readable storage medium further includes computer-executable instructions that, when executed by the processor, cause the processor to, responsive to a determination that the legibility score is less than a predetermined threshold, generate a bounding box around a text area of the first templatized image, generate a second templatized image with improved text legibility by selectively blurring a portion of the first templatized image that falls within the bounding box, and cause the surfacing of the second templatized image via the graphic design GUI.

In another embodiment, a computer-readable storage medium is described. The computer-readable storage medium includes computer-executable instructions that, when executed by a processor, cause the processor to cause execution of a graphics application and cause the surfacing of a graphic design GUI on a display during the execution of the graphics application. The computer-executable instructions, when executed by the processor, also cause the processor to, responsive to a user-initiated insertion of a desired image into a design template surfaced via the graphic design GUI, generate a first templatized image comprising text and assign a legibility score to the text within the first templatized image. The computer-executable instructions, when executed by the processor, further cause the processor to, responsive to a determination that the legibility score is less than a predetermined threshold, generate a bounding box around a text area of the first templatized image, generate a second templatized image with improved text legibility by selectively blurring a portion of the first templatized image that falls within the bounding box, and cause the surfacing of the second templatized image via the graphic design GUI.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1A is a schematic view of an exemplary design template that is selected by the user during execution of a graphics application;

FIG. 1B is a schematic view of a templatized image that is generated via the user-initiated insertion of a desired image into the design template of FIG. 1A;

FIG. 1C is a schematic view of several other templatized images that are generated by the design tool of the graphics application and are surfaced as design ideas for the user;

FIG. 2 is a process flow diagram of an exemplary method for automatically improving the legibility of text within graphic designs according to embodiments described herein;

FIG. 3A is a schematic view showing an exemplary implementation in which a bounding box is generated around the text area within the exemplary templatized image of FIG. 1B;

FIG. 3B is a schematic view of the portion of the templatized image that falls within the bounding box of FIG. 3A;

FIG. 3C is a schematic view of a blurred version of the portion of the templatized image from FIG. 3B;

FIG. 3D is a schematic view of a templatized image including a text area with improved text legibility, which is generated via the insertion of the blurred version of the portion of the templatized image that falls within the bounding box;

FIG. 3E is a schematic view of another templatized image including a text area with improved text legibility, which may be generated and provided as a design idea within the design idea window of the graphic design GUI;

FIG. 3F is a schematic view of another templatized image including a text area with improved text legibility, which may also be generated and provided as a design idea within the design idea window of the graphic design GUI;

FIG. 4 is a schematic view of an exemplary implementation of a graphic design GUI of a graphics application, which is surfaced during the execution of the graphics application on a computing system;

FIG. 5 is a process flow diagram of another exemplary method for automatically improving the legibility of text within graphic designs according to embodiments described herein;

FIG. 6 is a block diagram of an exemplary computing system for implementing the automatic text legibility improvement techniques described herein;

FIG. 7 is a block diagram of an exemplary network environment for implementing the automatic text legibility improvement techniques described herein; and

FIG. 8 is a block diagram of an exemplary computer-readable storage medium for implementing the automatic text legibility improvement techniques described herein.

### DETAILED DESCRIPTION

In general, the goal of modern creative design is to arrange images and text in such a way that the finished product is visually appealing and effectively communicates the intent of the design. To that end, graphics applications typically include text tools that enable users to blend typography with graphics or images, resulting in the creation of various types of graphic designs. Over the years, such text tools have grown in terms of importance and functionality, contributing to the design of increasingly complex and stunning graphic designs including text-related features. The overall goal of such text tools is to enable users to insert text in a manner that renders it clearly visible and legible. As a result, such text tools provide users with a large degree of control over the textual parameters, including, for example, the character spacing, kernings, alignment, font type, font color, font size, line length, and the like. However, such text tools are limited in the sense that they still require a large degree of user input and effort to ensure that the text is legible and visually appealing.

Some graphics applications offer design tools that receive the desired image and text as input and then output design ideas including suggested layouts or compositions. However, such design tools merely rearrange the content without making any determination regarding the legibility of the text within the image. Therefore, if the text is not legible, the user still has to manually edit the text by changing the font type, font color, and/or font size, for example. As a result, the design tools offered by conventional graphics applications often fail to provide design ideas that effectively communicate the overall intent of the design.

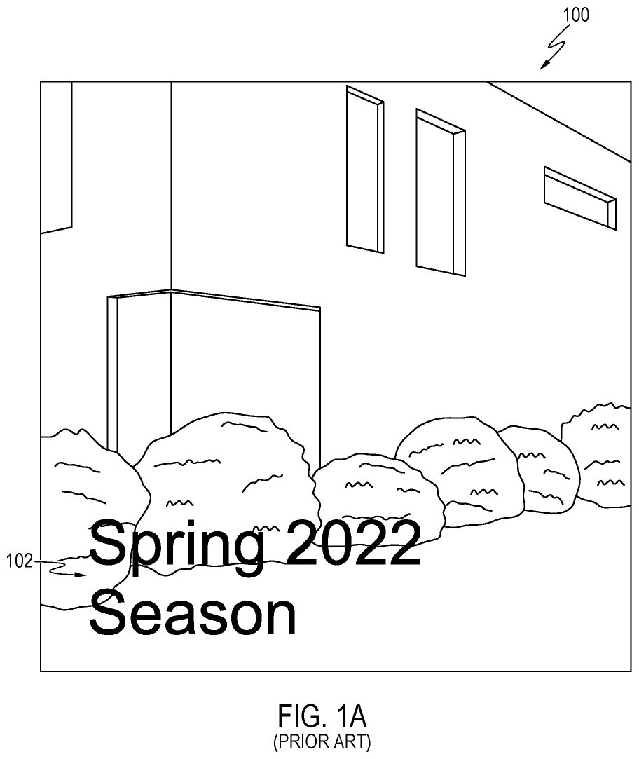

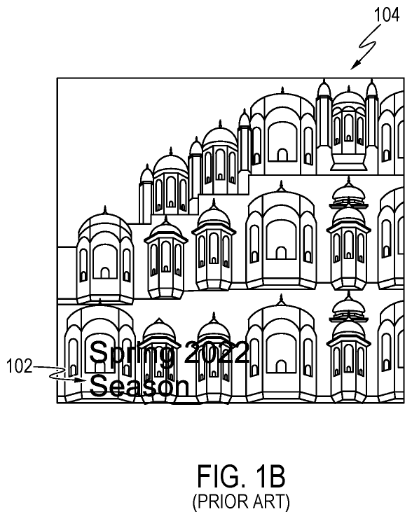

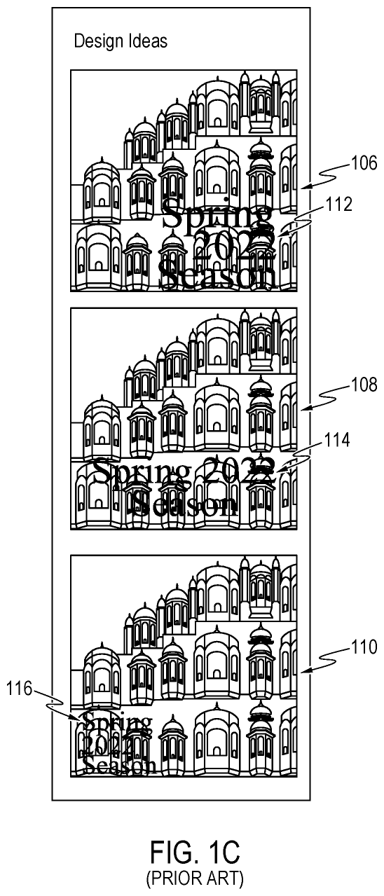

This issue is illustrated by the exemplary implementation shown in FIGS. 1A, 1B, and 1C. Specifically, FIG. 1A is a schematic view of an exemplary design template 100 that is selected by the user during execution of a graphics application. As shown in FIG. 1A, the design template 100 includes an image with an overlaid text area 102. In the initial design template 100, the white font color of the text area 102 contrasts with the color of the image and is thus clearly legible. However, FIGS. 1B and 1C demonstrate how this can create an issue for the user during the design process. Specifically, FIG. 1B is a schematic view of a templatized image 104 that is generated via the user-initiated insertion of a desired image into the design template 100 of FIG. 1A, while FIG. 1C is a schematic view of several other templatized images 106, 108, and 110 that are generated by the design tool of the graphics application and are surfaced as design ideas for the user. As shown in FIG. 1B, the color of the text area 102 does not sufficiently contrast with the color of the image and, thus, the text within the text area 102 is not highly legible within the templatized image 104. Similarly, the text areas 112, 114, and 116 within the templatized images 106, 108, and 110, respectively, do not sufficiently contrast with the color of the corresponding image and, thus, the text within such text areas 112, 114, and 116 is also not highly legible. As described above, this limits the effectiveness of the design tool and creates an issue for the user, who then has to manually adjust the textual parameters in order to increase the legibility of the text to an acceptable degree.

Therefore, the present techniques address these and other issues by providing for the automatic improvement of the legibility of text within graphic designs that are created using graphics applications. Specifically, the present techniques provide an improved design tool that automatically improves the legibility of text within a graphic design by selectively blurring the portion of the image that serves as background for the text. More specifically, the design tool of the graphics application accomplishes this by first determining whether the text within the graphic design falls below a predetermined minimum degree of legibility. If the text is below the predetermined minimum degree of legibility, the design tool generates a bounding box around the text area of the image and then blurs the portion of the image that falls within the bounding box. The graphics application may then surface the templatized image with the improved text legibility as a design idea, for example, within a design idea window of the graphical user interface (GUI) of the graphics application. Moreover, the design tool of the graphics application is designed to dynamically adapt to user-initiated changes in the underlying graphic design. For example, if the user moves the text area within the image, the design tool automatically adjusts the portion of the underlying image that is blurred such that it still corresponds to the text area. In this manner, the present techniques automatically provide the user with design ideas including highly-legible text with minimal user input, resulting in the generation of a graphic design that effectively communicates the user's overall intent in creating the graphic design.

Notably, the term “graphics application” as used herein refers to any application that provides image creation, design, editing, and/or formatting features with integrated text support, even if such features are not the primary purpose of the application. As a non-limiting example, if the application service provider is Microsoft Corporation, the graphics application described herein may include (but is not limited to) any number of Microsoft applications, including (but not limited to) Microsoft® Word®, Microsoft® PowerPoint®, and/or Designer on the web (among others).

The term “legibility” is used herein to refer to whether text is readable (i.e., “legible”) or unreadable (i.e., “illegible”). Moreover, such legibility may be described in terms of a degree of legibility (e.g., as defined by a legibility score), where text that is highly legible is relatively easy to discern and/or read, whereas text that is not highly legible is relatively difficulty to discern and/or read. Furthermore, according to embodiments described herein, references to text with “improved” legibility refers to text that has been transformed from a lower degree of legibility to a higher degree of legibility via the techniques described herein.

The term “text” is used broadly herein to refer to any type of characters that are inserted into a graphic design, regardless of whether the text includes traditional letters and/or proper words. Moreover, the term “image” is also used broadly herein to refer to any type of graphic (e.g., photograph, illustration, computerized drawing, or the like) that is inserted into a graphic design and is used, at least in part, as a background image for text that is inserted into the graphic design.

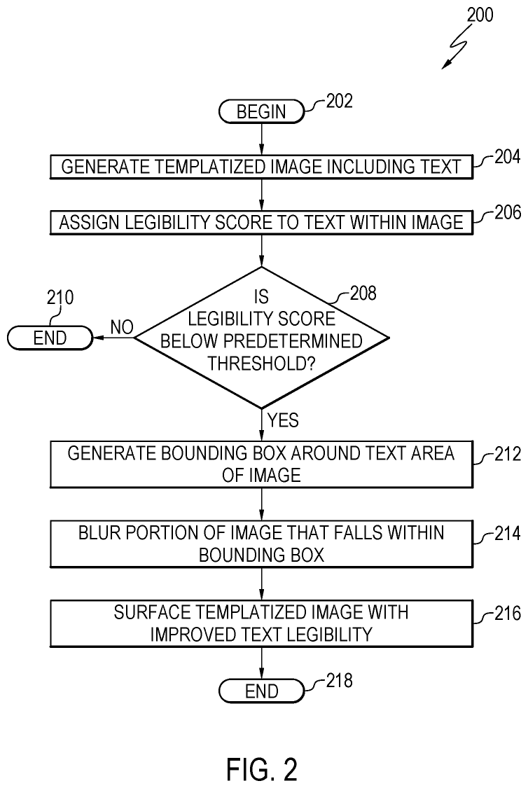

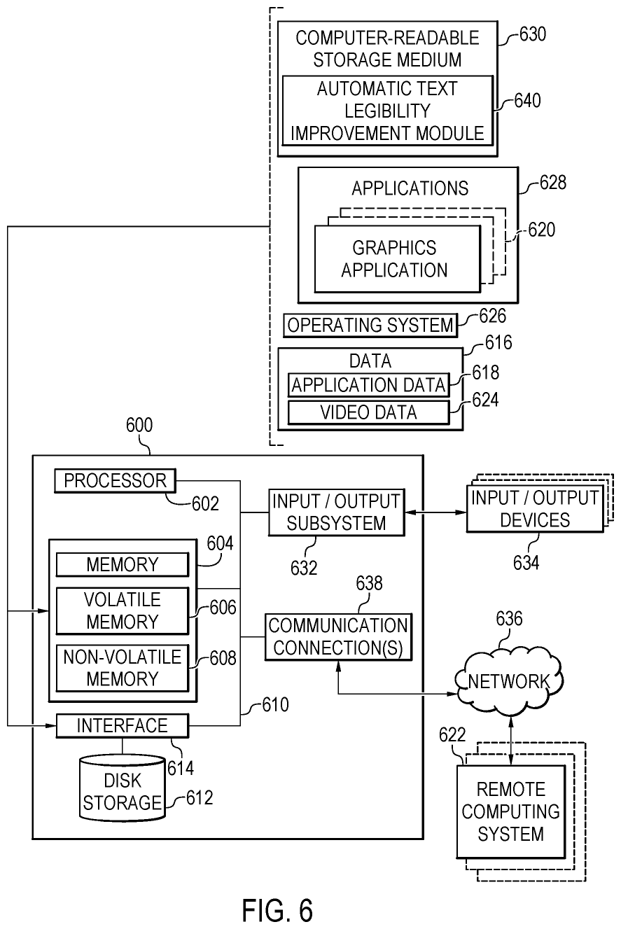

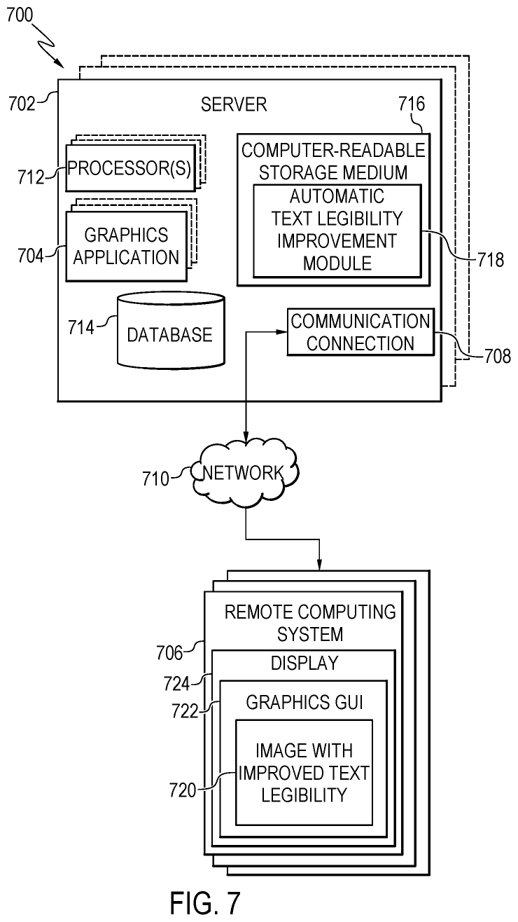

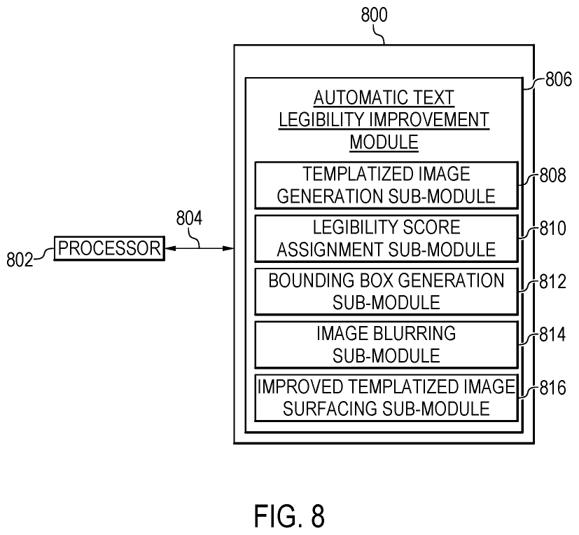

Turning now to details regarding the automatic text legibility improvement techniques described herein, FIG. 2 is a process flow diagram of an exemplary method 200 for automatically improving the legibility of text within graphic designs according to embodiments described herein. The method 200 is executed via one or more computing systems, such as the exemplary computing system described with respect to FIG. 6. In particular, in various embodiments, the computing system(s) implementing the method 200 includes computing system(s) or server(s) that are run by an application service provider that provides for the execution of one or more graphics applications on remote computing systems. The computing system(s) include one or more processors and one or more computer-readable storage media including computer-executable instructions that, when executed by the processor(s), cause the processor(s) to perform the blocks of the method 200. An exemplary embodiment of such computer-readable storage media is described with respect to FIG. 8. Moreover, in various embodiments, the method 200 is executed within the context of a network environment including one or more application service provider computing system(s)/server(s), as described further with respect to the exemplary network environment of FIG. 7.

The method 200 begins block 202. At block 204, a templatized image including text is generated via the user-initiated insertion of a desired image into a design template provided by a graphics application. At block 206, a legibility score is then assigned to the text within the image. In various embodiments, the legibility score is determined based on the contrast ratio between the text color and the background color (i.e., the color of the portion of the image on which the text is placed).

At block 208, a determination is made about whether the legibility score falls below a predetermined threshold. As an example, in various embodiments, the legibility score ranges between a value of 0 (meaning that the text is completely illegible) to 1.0 (meaning that the text is completely legible). In such embodiments, the predetermined threshold may be set to 0.5.

If it is determined at block 208 that the legibility score does not fall below the predetermined threshold, the method 200 ends at block 210. Continuing with the above example, this may be the case if the legibility score is greater than or equal to 0.5.

Conversely, if it is determined at block 208 that the legibility score does fall below the predetermined threshold, the method 200 proceeds to block 212, at which a bounding box is generated around the text area of the templatized image. Continuing with the above example, this may be the case if the legibility score is less than 0.5. Moreover, block 212 may include calculating the coordinates of the templatized image that mark the outer edges of the text and then utilizing such coordinates to generate a bounding box with a predetermined degree of offset from the outer edges of the text.

At block 214, the portion of the templatized image that falls within the bounding box is then selectively blurred. In some embodiments, this is accomplished by automatically extracting the portion of the templatized image that corresponds to the bounding box, applying a blurring effect to the image portion, and then inserting the blurred version of the image portion back into the templatized image as the background for the text area. Moreover, in various embodiments, the portion of the templatized image is blurred such that it blends with (or matches) the colors of the original image (i.e., the color(s) surrounding the blended area), thus ensuring that the overall graphic design remains visually appealing.

In various embodiments, the blurring effect that is applied to the image portion at block 214 includes the Box Blurring Technique (also referred to as the Averaging Technique). Within this context, an image is treated as a collection of pixels in a rectangular form, where the width of the image represents how many columns of pixels are present, and the height of the image represents how many rows of pixels are present. Thus, if an image has a resolution of 1920×1080, it includes 1920 columns of pixels and 1080 rows of pixels. Moreover, each pixels represents three values: (R, G, B), representing a red channel, a green channel, and a blue channel. These values represent the color of each pixel in RGB representation.

Turning now to details of the Box Blurring Technique, every pixel that lies within the image portion corresponding to the bounding box is replaced with the average value of all the pixels present in the bounding box. This is performed for each channel individually, i.e., for the red channel, the green channel, and the blue channel. Moreover, the average values of all the pixels present in the bounding box is determined for each channel individually by summing all the values present in each channel and then dividing by the number of values, thus calculating an average. This is shown below in Equations (1), (2), and (3).

$${Red}_{TextBoundingBox} = \frac{1}{{Width}_{Box} * {Height}_{Box}} {\sum }_{i = 1}^{{Width}_{Box}} {\sum }_{j = 1}^{{Height}_{Box}} {Red}_{i , j} \qquad ( 1 )$$

$${Green}_{TextBoundingBox} = \frac{1}{{Width}_{Box} * {Height}_{Box}} {\sum }_{i = 1}^{{Width}_{Box}} {\sum }_{j = 1}^{{Height}_{Box}} {Red}_{i , j} \qquad ( 2 )$$

$${Blue}_{TextBoundingBox} = \frac{1}{{Width}_{Box} * {Height}_{Box}} {\sum }_{i = 1}^{{Width}_{Box}} {\sum }_{j = 1}^{{Height}_{Box}} {Red}_{i , j} \qquad ( 3 )$$

In Equations (1), (2), and (3), the term Width_{Box} represents the width of the bounding box, and the term Height_{Box} represents the height of the bounding box. Moreover, those skilled in the art will appreciate that any other suitable blurring technique may additionally or alternatively be utilized according to the present techniques, depending on the details of the particular implementation.

At block 216, the templatized image with the improved text legibility is then surfaced within the graphic design GUI of the graphics application. As an example, in some embodiments, the resulting templatized image is surfaced within the design editing window of the graphic design GUI. In other embodiments, the resulting templatized image is surfaced as a design idea within a design idea window of the graphic design GUI. In some embodiments the method 200 then ends at block 218.

The block diagram of FIG. 2 is not intended to indicate that the blocks of the method 200 are to be executed in any particular order, or that all of the blocks of the method 200 are to be included in every case. Moreover, any number of additional blocks may be included within the method 200, depending on the details of the specific implementation. For example, in various embodiments, the method 200 also includes dynamically adapting the templatized image that is output at block 214 based on user-initiated changes in the underlying graphic design. For example, if the user moves the text area within the templatized image, the method 200 may further include automatically adjusting the bounding box and, thus, the portion of the templatized image that is blurred such that it still corresponds to the text area.

Furthermore, in various embodiments, the method 200 may include automatically generating multiple templatized images with improved text legibility based on the single, initial templatized image. Such templatized images with improved text legibility may then be surfaced as additional design ideas within the design idea window of the graphic design GUI.

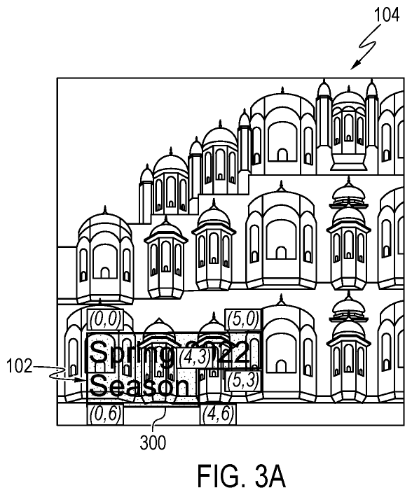

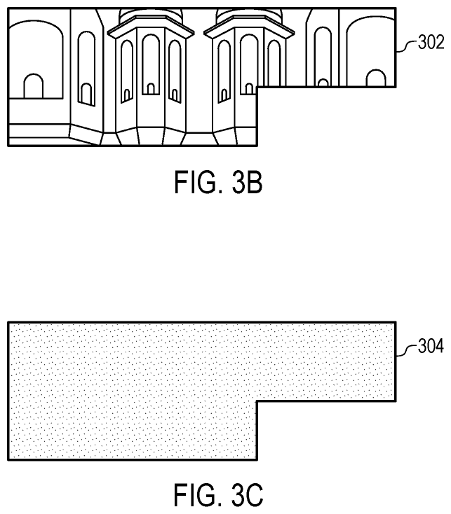

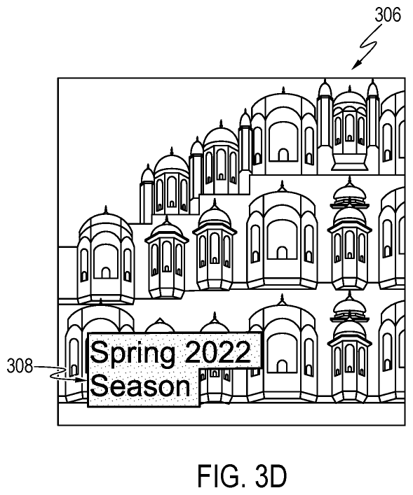

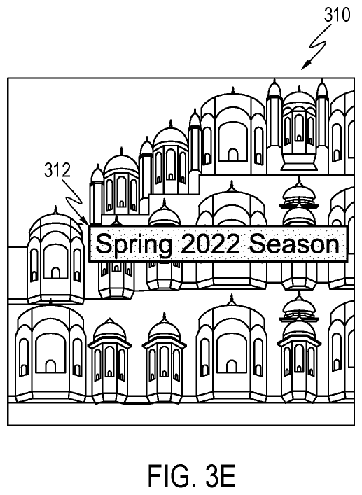

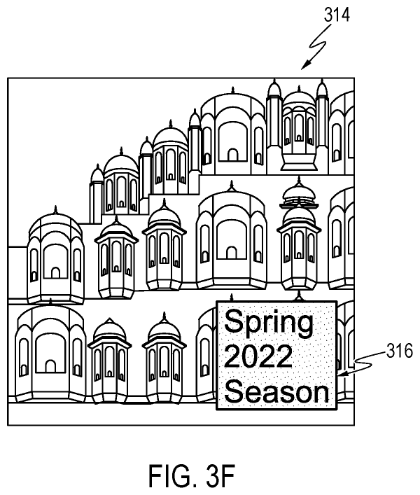

FIG. 3A is a schematic view showing an exemplary implementation in which a bounding box 300 is generated around the text area 102 within the exemplary templatized image 104 of FIG. 1B. As shown in FIG. 3A, the bounding box 300 is generated, at least in part, based on the coordinates of the outer edges of the text within the templatized image 104. Moreover, as also shown in FIG. 3A, the bounding box is generated with a predetermined degree of offset from the outer edges of the text.

FIG. 3B is a schematic view of the portion 302 of the templatized image 104 that falls within the bounding box 300 of FIG. 3A. FIG. 3C is a schematic view of a blurred version 304 of the portion 302 of the templatized image 104 from FIG. 3B. Moreover, FIG. 3D is a schematic view of a templatized image 306 including a text area 308 with improved text legibility, which is generated via the insertion of the blurred version 304 of the portion 302 of the templatized image 104 that falls within the bounding box 300.

FIG. 3E is a schematic view of another templatized image 310 including a text area 312 with improved text legibility, which may be generated and provided as a design idea within the design idea window of the graphic design GUI. Furthermore, FIG. 3F is a schematic view of another templatized image 314 including a text area 316 with improved text legibility, which may also be generated and provided as a design idea within the design idea window of the graphic design GUI. Notably, FIGS. 3E and 3F also demonstrate the manner in which the present techniques automatically adapt to user-initiated changes in the underlying graphic design. In particular, as the text area within the templatized image is moved or dragged around the design canvas within the design editing window, the graphics application automatically blurs the appropriate portion of the image to maintain the high degree of text legibility.

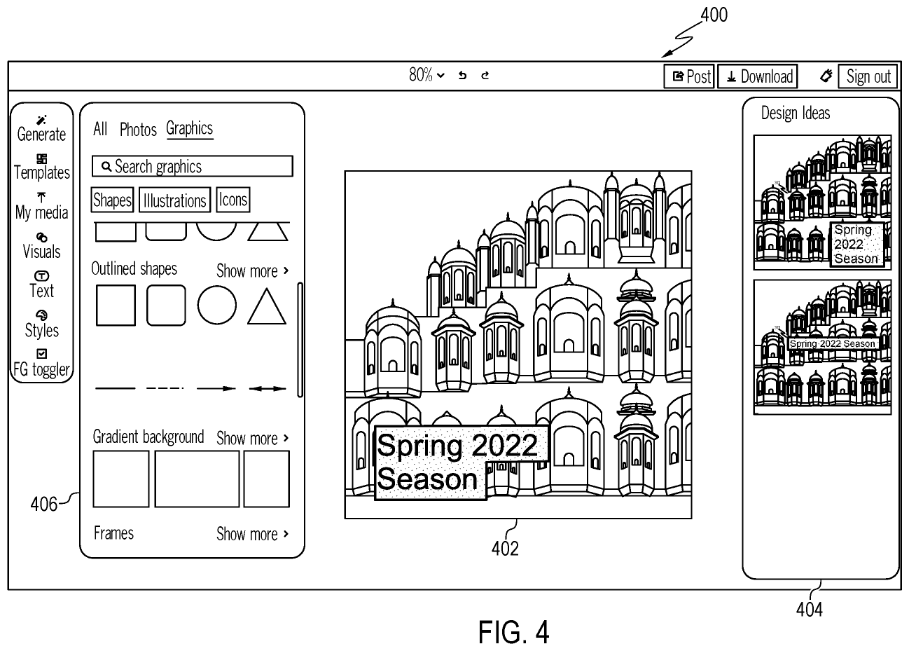

FIG. 4 is a schematic view of an exemplary implementation of a graphic design GUI 400 of a graphics application, which is surfaced during the execution of the graphics application on a computing system. As shown in FIG. 4, the exemplary graphic design GUI includes a design editing window 402 for creating/editing a graphic design, a design idea window 404 that provides suggestions for the graphic design, and various UI elements 406 that enable the user to create/edit the graphic design.

Those skilled in the art will appreciate that the exemplary implementations described with respect to FIGS. 3A-F and 4 are for illustrative purposes only. In practice, the techniques described herein may be implemented in any other suitable manner to achieve any other suitable results, depending on the details of the particular implementation.

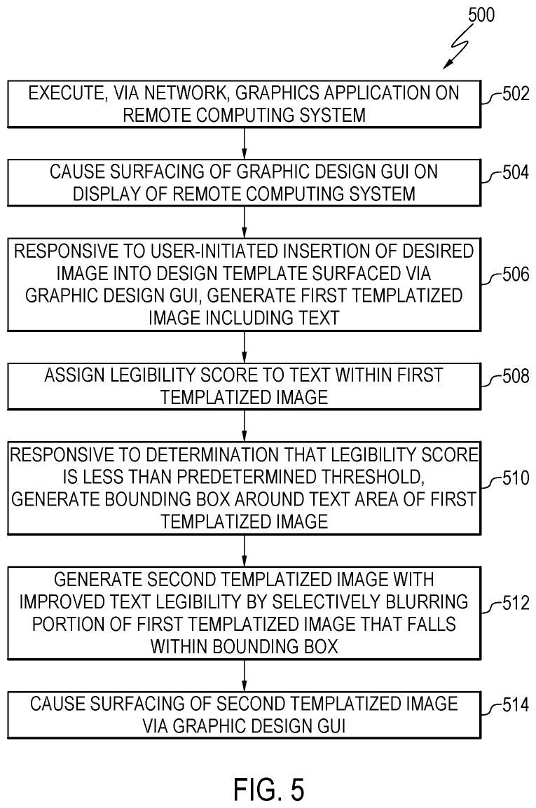

FIG. 5 is a process flow diagram of another exemplary method 500 for automatically improving the legibility of text within graphic designs according to embodiments described herein. The method 500 is executed via one or more computing systems, such as the exemplary computing system described with respect to FIG. 6. In particular, in various embodiments, the computing system(s) implementing the method 500 includes computing system(s) or server(s) that are run by an application service provider that provides for the execution of one or more graphics applications on remote computing systems. The computing system(s) include one or more processors and one or more computer-readable storage media including computer-executable instructions that, when executed by the processor(s), cause the processor(s) to perform the blocks of the method 500. An exemplary embodiment of such computer-readable storage media is described with respect to FIG. 8. Moreover, in various embodiments, the method 500 is executed within the context of a network environment including one or more application service provider computing system(s)/server(s), as described further with respect to the exemplary network environment of FIG. 7.

The method 500 begins block 502, at which a graphics application is executed on a remote computing system via a network. At block 504, a graphic design GUI is caused to be surfaced on a display of the remote computing system during the execution of the graphics application.

At block 506, a first templatized image including text is generated responsive to the user-initiated insertion of a desired image into a design template surfaced via the graphic design GUI. At block 508, a legibility score is assigned to the text within the first templatized image. In various embodiments, this is accomplished, at least in part, by calculating a contrast ratio between the text color of the text and the background color of the first templatized image.

At block 510, a bounding box is generated around the text area of the first templatized image responsive to a determination that the legibility score is less than a predetermined threshold. In various embodiments, this is accomplished, at least in part, by calculating the coordinates of the first templatized image that mark the outer edges of the text and utilizing the coordinates to generate the bounding box with a predetermined degree of offset from the outer edges of the text.

At block 512, a second templatized image with improved text legibility is generated by selectively blurring a portion of the first templatized image that falls within the bounding box. In various embodiments, the selective blurring is performed such that the resulting blurred portion of the second templatized image blends into the surrounding colors within the second templatized image.

Further, at block 514, the second templatized image is caused to be surfaced via the graphic design GUI. In some embodiments, the second templatized image is surfaced within a design idea window of the graphic design GUI. In other embodiments, the second templatized image is surfaced within a design editing window of the graphic design GUI.

The block diagram of FIG. 5 is not intended to indicate that the blocks of the method 500 are to be executed in any particular order, or that all of the blocks of the method 500 are to be included in every case. Moreover, any number of additional blocks may be included within the method 500, depending on the details of the specific implementation. As an example, in various embodiments, the method 500 also includes dynamically adapting the second templatized image responsive to a user-initiated change in the position of the text within the first templatized image. As another example, in various embodiments, the method 500 also includes automatically generating multiple additional templatized images with improved text legibility based on the first templatized image, as well as causing the surfacing of the additional templatized images within a design idea window of the graphic design GUI.

The present techniques provide various advantages over conventional graphic design solutions. As an example, the present techniques provide automatic text legibility improvement within graphic designs via the selective blurring of image portions that correspond to text regions within graphic designs. As another example, the present techniques provide a dynamic text legibility improvement solution that automatically adapts to user-initiated changes in the underlying graphic design, including movement of the text area around the design canvas. As another example, the ability of the present techniques to execute automatically without significant user input reduces the workflow burden on the user (especially for users who are not experienced graphic designers) and increases the ease with which highly-quality, visually-appealing graphic designs can be created. As another example, the present techniques are integrated into the design ideas window of the graphic design GUI of the corresponding graphics application to provide design suggestions for users, thus increasing the ease with which users can create a high-quality, visually-appealing graphic design. As another example, the present techniques allow users to effectively utilize any desired template to produce a high-quality, visually-appealing graphic design including highly-legible text. As another example, the present techniques can be integrated into any type of graphic design tool or application that involves creating graphic designs including textual features.

FIG. 6 is a block diagram of an exemplary computing system 600 for implementing the automatic text legibility improvement techniques described herein. The exemplary computing system 600 includes a processor 602 and a memory 604. The processor 602 may include any suitable type of processing unit or device, such as, for example, a single-core processor, a multi-core processor, a computing cluster, or any number of other configurations. Moreover, the processor 602 may include, for example, an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein.

The memory 604 typically (but not always) includes both volatile memory 606 and non-volatile memory 608. The volatile memory 606 retains or stores information so long as the memory is supplied with power. By contrast, the non-volatile memory 608 is capable of storing (or persisting) information even when a power supply is not available. The volatile memory 606 may include, for example, RAM (e.g., synchronous RAM (SRAM), dynamic RAM (DRAM), synchronous dynamic RAM (SDRAM), and the like) and CPU cache memory. The nonvolatile memory 608 may include, for example, read-only memory (ROM) (e.g., programmable ROM (PROM), electrically programmable ROM (EPROM), electrically erasable ROM (EEROM) or the like), flash memory, nonvolatile random-access memory (RAM), solid-state memory devices, memory storage devices, and/or memory cards.

The processor 602 and the memory 604, as well as other components of the computing system 600, are interconnected by way of a system bus 610. The system bus 610 can be implemented using any suitable bus architecture known to those skilled in the art.

According to the embodiment shown in FIG. 6, the computing system 600 also includes a disk storage 612. The disk storage 612 may include any suitable removable/non-removable, volatile/non-volatile storage component or device. For example, the disk storage 612 may include, but is not limited to, a magnetic disk drive, floppy disk drive, tape drive, Jaz drive, Zip drive, LS-210 drive, flash memory card, memory stick, or the like. In addition, the disk storage 612 may include storage media separately from (or in combination with) other storage media including, but not limited to, an optical disk drive, such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 612 to the system bus 610, a removable or non-removable interface is typically used, such as interface 614 shown in FIG. 6.

In various embodiments, the disk storage 612 and/or the memory 604 function as one or more databases that are used to store data 616 relating to the techniques described herein. Such data 616 may include, but are not limited to, application data 618 obtained from the execution of one or more graphics application(s) 620 on various remote computing systems 622. According to embodiments described herein, such application data 618 may include data relating to a text legibility improvement functionality of the graphics application(s) 620. Such data 616 may also include, but are not limited to, graphics data 624 corresponding to any number of images that are created, designed, and/or edited using the graphics application(s) 620.

Those skilled in the art will appreciate that FIG. 6 describes software that acts as an intermediary between a user of the computing system 600 and the basic computing resources described with respect to the operating environment of the computing system 600. Such software includes an operating system 626. The operating system 626, which may be stored on the disk storage 612, acts to control and allocate the computing resources of the computing system 600. Moreover, system applications 628, including the graphics application(s) 620, take advantage of the management of the computing resources by the operating system 626 through one or more program modules stored within a computer-readable storage medium (or media) 630, as described further herein.

The computing system 600 also includes an input/output (I/O) subsystem 632. The I/O subsystem 632 includes a set of hardware, software, and/or firmware components that enable or facilitate inter-communication between the user of the computing system 600 and the processor 602 of the computing system 600. During operation of the computing system 600, the I/O subsystem 632 enables the user to interact with the computing system 600 through one or more I/O devices 634. Such I/O devices 634 may include any number of input devices or channels, such as, for example, one or more touchscreen/haptic input devices, one or more buttons, one or more pointing devices, one or more accessories, one or more audio input devices, and/or one or more video input devices, such as a camera. Furthermore, in some embodiments the one or more input devices or channels connect to the processor 602 through the system bus 610 via one or more interface ports (not shown) integrated within the I/O subsystem 632. Such interface ports may include, for example, a serial port, a parallel port, a game port, and/or a universal serial bus (USB).

In addition, such I/O devices 634 may include any number of output devices or channels, such as, for example, one or more audio output devices, one or more haptic feedback devices, and/or one or more display devices. Such output devices or channels may use some of the same types of ports as the input devices or channels. Thus, for example, a USB port may be used to both provide input to the computing system 600 and to output information from the computing system 600 to a corresponding output device. Moreover, in some embodiments, the one or more output devices or channels are accessible via one or more adapters (not shown) integrated within the I/O subsystem 632.

In various embodiments, the computing system 600 is communicably coupled to any number of remote computing systems 622. The remote computing system(s) 622 may include, for example, one or more personal computers (e.g., desktop computers, laptop computers, or the like), one or more tablets, one or more mobile devices (e.g., mobile phones), one or more network PCs, and/or one or more workstations. As an example, in some embodiments, the computing system 600 is an application service provider server hosting the graphics application(s) 620 in a networked environment using logical connections to the remote computing systems 622. In such embodiments, the computing system 600 provides for the execution of the graphics application(s) 620 on the remote computing systems 622 with the enhanced functionality provided by the automatic text legibility improvement techniques described herein.

In various embodiments, the remote computing systems 622 are logically connected to the computing system 600 through a network 636 and then connected via a communication connection 638, which may be wireless. The network 636 encompasses wireless communication networks, such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

The communication connection 638 includes the hardware/software employed to connect the network 636 to the bus 610. While the communication connection 638 is shown for illustrative clarity as residing inside the computing system 600, it can also be external to the computing system 600. The hardware/software for connection to the network 636 may include, for example, internal and external technologies, such as mobile phone switches, modems including regular telephone grade modems, cable modems and DSL modems, ISDN adapters, and/or Ethernet cards.

As described above, the system applications 628, such as the graphics application(s) 620, take advantage of the management of the computing resources by the operating system 626 through one or more program modules stored within the computer-readable storage medium (or media) 630. In some embodiments, the computer-readable storage medium 630 is integral to the computing system 600, in which case it may form part of the memory 604 and/or the disk storage 612. In other embodiments, the computer-readable storage medium 630 is an external device that is connected to the computing system 600 when in use.

In various embodiments, the one or more program modules stored within the computer-readable storage medium 630 include program instructions or code that may be executed by the processor 602 to perform various operations. In various embodiments, such program modules include, but are not limited to, an automatic text legibility improvement module 640 that causes the processor 602 to perform operations that result in the execution of the automatic text legibility improvement techniques provided herein, as described with respect to the method 200 of FIG. 2 and/or the method 500 of FIG. 5, for example. In particular, in various embodiments, the execution of the graphics application(s) 620 in conjunction with the automatic text legibility improvement module 640 may result in the improvement or enhancement of the legibility of text within one or more graphic designs that are created using the graphics application(s) 620.

It is to be understood that the block diagram of FIG. 6 is not intended to indicate that the computing system 600 is to include all of the components shown in FIG. 6. Rather, the computing system 600 can include fewer or additional components not illustrated in FIG. 6 (e.g., additional applications, additional modules, additional memory devices, additional network interfaces, etc.). Furthermore, any of the functionalities of the one or more program modules/sub-modules may be partially, or entirely, implemented in hardware and/or in the processor 602. For example, the functionality may be implemented with an application specific integrated circuit, in logic implemented in the processor 602, or in any other device.

FIG. 7 is a block diagram of an exemplary network environment 700 for implementing the automatic text legibility improvement techniques described herein. As shown in FIG. 7, the network environment 700 includes one or more server(s) 702 that provide for the execution of the techniques described herein. In various embodiments, the server(s) 702 are operated by an application service provider that provides for the execution of one or more graphics application(s) 704. In addition, the network environment 700 may include any number of remote computing systems 706.

In various embodiments, the server(s) 702 are configured to communicate with the remote computing system(s) 706 via a communication connection 708 and a corresponding network 710 (e.g., using one or more application programming interfaces (APIs) corresponding to the graphics application(s) 704, for example). The network 710 may include, but is not limited to, a cellular network, a point-to-point dial up connection, a satellite network, the Internet, a local area network (LAN), a wide area network (WAN), and/or a Wi-Fi network. Such networks are widely used to connect various types of network elements, such as routers, servers, and gateways. Moreover, those skilled in the art will appreciate that the present techniques may also be practiced in a multi-network environment having various connected public and/or private networks. Furthermore, those skilled in the art will appreciate that communication networks can take several different forms and use several different communication protocols. For example, in some embodiments, the present techniques may be practiced in a distributed computing environment in which tasks are performed by remote processing devices that are linked through a communications network. In a distributed computing environment, program modules can be located in both local and remote computer-readable storage media.

In various embodiments, the server(s) 702 include one or more processors 712, as well as a database 714 that functions as a repository for the data that is generated and maintained according to embodiments described herein, as described with respect to FIG. 6. In addition, the server(s) 702 include a computer-readable storage medium 716 including an automatic text legibility improvement module 718 that directs the processor(s) 712 to perform the techniques described herein to generate one or more images 720 with improved text legibility during the execution of the graphics application(s) 704 on the remote computing system(s) 706.

In some embodiments, the server(s) 702 maintain the code corresponding to the graphics application(s) 704. In such embodiments, the server(s) 702 may host the graphics application(s) 704 on the remote computing system(s) 706 via the network 710 (e.g., using the corresponding APIs). In particular, the server(s) 702 provide for execution of the graphics application(s) 704 on the remote computing system(s) 706 by surfacing a graphic design GUI 722 on a display 724 corresponding to each remote computing system 706. The image(s) 720 with the improved text legibility can then be surfaced via the graphic design GUI 722.

It is to be understood that the simplified block diagram of FIG. 7 is not intended to indicate that the network environment 700 is to include all of the components shown in FIG. 7. Rather, the network environment 700 may include different components and/or additional components not illustrated in FIG. 7. For example, in practice, the server(s) 702 will include a number of additional components not depicted in the simplified block diagram of FIG. 7, as described with respect to the computing system 600 of FIG. 6, for example.

FIG. 8 is a block diagram of an exemplary computer-readable storage medium 800 for implementing the automatic text legibility improvement techniques described herein. In various embodiments, the computer-readable storage medium 800 is accessed by a processor 802 over a computer interconnect 804. For example, in some embodiments, the computer-readable storage medium 800 is the same as, or similar to, the computer-readable storage medium described with respect to the computing system 600 of FIG. 6 and/or the network environment 700 of FIG. 7.

In various embodiments, the computer-readable storage medium 800 includes code (i.e., computer-executable instructions) to direct the processor 802 to perform the operations of the present techniques. Such code may be stored within the computer-readable storage medium 800 in the form of program modules, where each module includes a set of computer-executable instructions that, when executed by the processor 802, cause the processor 802 to perform a corresponding set of operations. In particular, in various embodiments, the computer-readable storage medium 800 includes an automatic text legibility improvement module 806 that directs the processor 802 to perform the automatic text legibility improvement techniques described herein. Moreover, in various embodiments, the automatic text legibility improvement module 806 accomplishes this via one or more sub-modules. Such sub-modules may include, but are not limited to, a templatized image generation sub-module 808, a legibility score assignment sub-module 810, a bounding box generation sub-module 812, an image blurring sub-module 814, and an improved templatized image surfacing sub-module 816.

Moreover, those skilled in the art will appreciate that any suitable number of the modules shown in FIG. 8 may be included within the computer-readable storage medium 800. Furthermore, any number of additional modules/sub-modules not shown in FIG. 8 may be included within the computer-readable storage medium 800, depending on the details of the specific implementation.

It should be noted that some components shown in the figures are described herein in the context of one or more structural components, referred to as functionalities, modules, features, elements, etc. However, the components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computing systems, discrete logic components, such as application specific integrated circuits (ASICs), and the like, as well as any combinations thereof.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, the terms “component,” “system,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable storage medium.

Moreover, as used herein, the term “computer-readable storage medium” refers to an article of manufacture. In general, computer-readable storage media are used to host, store and/or reproduce computer-executable instructions and data for later retrieval and/or execution. When the computer-executable instructions that are hosted or stored on the computer-readable storage media are executed by a processor of a computing system, the execution thereof causes, configures and/or adapts the executing computing system to carry out various steps, processes, routines, methods and/or functionalities, including the steps, processes, routines, methods, and/or functionalities described herein. Examples of computer-readable storage media include, but are not limited to, optical storage media (such as Blu-ray discs, digital video discs (DVDs), compact discs (CDs), optical disc cartridges, and the like), magnetic storage media (such as hard disk drives, floppy disks, magnetic tape, and the like), memory storage devices (such as random access memory (RAM), read-only memory (ROM), memory cards, thumb drives, and the like), and cloud storage (such as online storage services). Computer-readable storage media may deliver computer-executable instructions to a computing system for execution via various transmission means and mediums, including carrier waves and/or propagated signals. However, for purposes of this disclosure, the term “computer-readable storage medium (or media)” refers specifically to non-transitory forms of computer-readable storage media and expressly excludes carrier waves and/or propagated signals.

The present techniques may be susceptible to various modifications and alternative forms, including (but not limited to) those described in the following examples:

Example 1 is a method for automatically improving the legibility of text within a graphic design. The method is implemented via a computing system including a processor. The method includes: executing, via a network, a graphics application on a remote computing system; causing surfacing of a graphic design GUI on a display of the remote computing system during the execution of the graphics application; responsive to a user-initiated insertion of a desired image into a design template surfaced via the graphic design GUI, generating a first templatized image including text; assigning a legibility score to the text within the first templatized image; responsive to a determination that the legibility score is less than a predetermined threshold, generating a bounding box around a text area of the first templatized image; generating a second templatized image with improved text legibility by selectively blurring a portion of the first templatized image that falls within the bounding box; and causing surfacing of the second templatized image via the graphic design GUI.

Example 2 includes the method of example 1, including or excluding optional features. In this example, the method includes dynamically adapting the second templatized image responsive to a user-initiated change in a position of the text within the first templatized image.

Example 3 includes the method of example 1 or 2, including or excluding optional features. In this example, the method includes: automatically generating multiple additional templatized images with improved text legibility based on the first templatized image; and causing surfacing of the additional templatized images within a design idea window of the graphic design GUI.

Example 4 includes the method of any one of examples 1 to 3, including or excluding optional features. In this example, the method includes assigning the legibility score to the text within the first templatized image by calculating a contrast ratio between a text color of the text and a background color of the first templatized image.

Example 5 includes the method of any one of examples 1 to 4, including or excluding optional features. In this example, the method includes generating the bounding box around the text area of the first templatized image by: calculating coordinates of the first templatized image that mark outer edges of the text; and utilizing the coordinates to generate the bounding box with a predetermined degree of offset from the outer edges of the text.

Example 6 includes the method of any one of examples 1 to 5, including or excluding optional features. In this example, the method includes performing the selective blurring such that a resulting blurred portion of the second templatized image blends into surrounding colors within the second templatized image.

Example 7 includes the method of any one of examples 1 to 6, including or excluding optional features. In this example, the method includes causing surfacing of the second templatized image within a design idea window of the graphic design GUI.

Example 8 includes the method of any one of examples 1 to 7, including or excluding optional features. In this example, the method includes causing surfacing of the second templatized image within a design editing window of the graphic design GUI.

Example 9 is a server. The server includes: a processor; a graphics application with integrated text support; a communication connection for connecting a remote computing system to the server via a network; and a computer-readable storage medium operatively coupled to the processor. The computer-readable storage medium includes computer-executable instructions that, when executed by the processor, cause the processor to: execute, via the network, the graphics application on the remote computing system; cause surfacing of a graphic design GUI on a display of the remote computing system during the execution of the graphics application; responsive to a user-initiated insertion of a desired image into a design template surfaced via the graphic design GUI, generate a first templatized image including text; assign a legibility score to the text within the first templatized image; responsive to a determination that the legibility score is less than a predetermined threshold, generate a bounding box around a text area of the first templatized image; generate a second templatized image with improved text legibility by selectively blurring a portion of the first templatized image that falls within the bounding box; and cause surfacing of the second templatized image via the graphic design GUI.

Example 10 includes the server of example 9, including or excluding optional features. In this example, the computer-executable instructions, when executed by the processor, cause the processor to dynamically adapt the second templatized image responsive to a user-initiated change in a position of the text within the first templatized image.

Example 11 includes the server of example 9 or 10, including or excluding optional features. In this example, the computer-executable instructions, when executed by the processor, cause the processor to: automatically generate multiple additional templatized images with improved text legibility based on the first templatized image; and cause surfacing of the additional templatized images within a design idea window of the graphic design GUI.

Example 12 includes the server of any one of examples 9 to 11, including or excluding optional features. In this example, the computer-executable instructions, when executed by the processor, cause the processor to assign the legibility score to the text within the first templatized image by calculating a contrast ratio between a text color of the text and a background color of the first templatized image.

Example 13 includes the server of any one of examples 9 to 12, including or excluding optional features. In this example, the computer-executable instructions, when executed by the processor, cause the processor to generate the bounding box around the text area of the first templatized image by: calculating coordinates of the first templatized image that mark outer edges of the text; and utilizing the coordinates to generate the bounding box with a predetermined degree of offset from the outer edges of the text.

Example 14 includes the server of any one of examples 9 to 13, including or excluding optional features. In this example, the computer-executable instructions, when executed by the processor, cause the processor to perform the selective blurring such that a resulting blurred portion of the second templatized image blends into surrounding colors within the second templatized image.

Example 15 includes the server of any one of examples 9 to 14, including or excluding optional features. In this example, the computer-executable instructions, when executed by the processor, cause the processor to cause surfacing of the second templatized image within a design idea window of the graphic design GUI.

Example 16 includes the server of any one of examples 9 to 15, including or excluding optional features. In this example, the computer-executable instructions, when executed by the processor, cause the processor to cause surfacing of the second templatized image within a design editing window of the graphic design GUI.

Example 17 is a computer-readable storage medium. The computer-readable storage medium includes computer-executable instructions that, when executed by a processor, cause the processor to: cause execution of a graphics application; cause surfacing of a graphic design GUI on a display during the execution of the graphics application; responsive to a user-initiated insertion of a desired image into a design template surfaced via the graphic design GUI, generate a first templatized image including text; assign a legibility score to the text within the first templatized image; responsive to a determination that the legibility score is less than a predetermined threshold, generate a bounding box around a text area of the first templatized image; generate a second templatized image with improved text legibility by selectively blurring a portion of the first templatized image that falls within the bounding box; and cause surfacing of the second templatized image via the graphic design GUI.

Example 18 includes the computer-readable storage medium of example 17, including or excluding optional features. In this example, the computer-executable instructions, when executed by the processor, cause the processor to dynamically adapt the second templatized image responsive to a user-initiated change in a position of the text within the first templatized image.

Example 19 includes the computer-readable storage medium of example 17 or 18, including or excluding optional features. In this example, the computer-executable instructions, when executed by the processor, cause the processor to:

automatically generate multiple additional templatized images with improved text legibility based on the first templatized image; and cause surfacing of the additional templatized images within a design idea window of the graphic design GUI.

Example 20 includes the computer-readable storage medium of any one of examples 17 to 19, including or excluding optional features. In this example, the computer-executable instructions, when executed by the processor, cause the processor to assign the legibility score to the text within the first templatized image by calculating a contrast ratio between a text color of the text and a background color of the first templatized image.

It should be noted that, while the methods and processes described herein are generally expressed in regard to discrete steps, these steps should be viewed as being logical in nature and may or may not correspond to any specific actual and/or discrete steps of a given implementation. In addition, the order in which these steps are presented in the various methods and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while the methods and processes described herein include various novel features of the disclosed subject matter, other steps (not listed) may also be carried out in the execution of the subject matter set forth in these methods and processes. Those skilled in the art will appreciate that the logical steps of these methods and processes may be combined together or split into additional steps. Steps of the above-described methods and processes may be carried out in parallel or in series. Often, but not exclusively, the functionality of a particular method or process is embodied in software (e.g., applications, system services, libraries, and the like) that is executed on one or more processors of computing systems. Additionally, in various embodiments, all or some of the various methods and processes may also be embodied in executable hardware modules including, but not limited to, system on chips (SoC's), codecs, specially designed processors and/or logic circuits, and the like, on a computing system.

As suggested above, each method or process described herein is typically embodied within computer-executable instruction (or code) modules including individual routines, functions, looping structures, selectors, and switches (such as if-then and if-then-else statements), assignments, arithmetic computations, and the like, that, in execution, configure a computing system to operate in accordance with the particular method or process. However, as suggested above, the exact implementation in executable statement of each of the methods or processes is based on various implementation configurations and decisions, including programming languages, compilers, target processors, operating environments, and the linking or binding operation. Those skilled in the art will readily appreciate that the logical steps identified in these methods and processes may be implemented in any number of ways and, thus, the logical descriptions set forth above are sufficiently enabling to achieve similar results.

While various novel aspects of the disclosed subject matter have been described, it should be appreciated that these aspects are exemplary and should not be construed as limiting. Variations and alterations to the various aspects may be made without departing from the scope of the disclosed subject matter.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for automatically improving the legibility of text within a graphic design, wherein the method is implemented via a computing system comprising a processor, and wherein the method comprises:
executing, via a network, a graphics application on a remote computing system;
causing surfacing of a graphic design graphical user interface (GUI) on a display of the remote computing system during the execution of the graphics application;
responsive to a user-initiated insertion of a desired image into a design template surfaced via the graphic design GUI, generating a first templatized image comprising text;
assigning a legibility score to the text within the first templatized image;
responsive to a determination that the legibility score is less than a predetermined threshold, generating a bounding box around a text area of the first templatized image;
generating a second templatized image with improved text legibility by selectively blurring a portion of the first templatized image that falls within the bounding box; and
causing surfacing of the second templatized image via the graphic design GUI.

2. The method of claim 1, comprising dynamically adapting the second templatized image responsive to a user-initiated change in a position of the text within the first templatized image.

3. The method of claim 1, comprising:
automatically generating multiple additional templatized images with improved text legibility based on the first templatized image; and
causing surfacing of the additional templatized images within a design idea window of the graphic design GUI.

4. The method of claim 1, comprising assigning the legibility score to the text within the first templatized image by calculating a contrast ratio between a text color of the text and a background color of the first templatized image.

5. The method of claim 1, comprising generating the bounding box around the text area of the first templatized image by:
calculating coordinates of the first templatized image that mark outer edges of the text; and
utilizing the coordinates to generate the bounding box with a predetermined degree of offset from the outer edges of the text.

6. The method of claim 1, comprising performing the selective blurring such that a resulting blurred portion of the second templatized image blends into surrounding colors within the second templatized image.

7. The method of claim 1, comprising causing surfacing of the second templatized image within a design idea window of the graphic design GUI.

8. The method of claim 1, comprising causing surfacing of the second templatized image within a design editing window of the graphic design GUI.

9. A server, comprising:
a processor;
a graphics application with integrated text support;
a communication connection for connecting a remote computing system to the server via a network; and
a computer-readable storage medium operatively coupled to the processor, the computer-readable storage medium comprising computer-executable instructions that, when executed by the processor, cause the processor to:
execute, via the network, the graphics application on the remote computing system;
cause surfacing of a graphic design graphical user interface (GUI) on a display of the remote computing system during the execution of the graphics application;
responsive to a user-initiated insertion of a desired image into a design template surfaced via the graphic design GUI, generate a first templatized image comprising text;
assign a legibility score to the text within the first templatized image;
responsive to a determination that the legibility score is less than a predetermined threshold, generate a bounding box around a text area of the first templatized image;
generate a second templatized image with improved text legibility by selectively blurring a portion of the first templatized image that falls within the bounding box; and
cause surfacing of the second templatized image via the graphic design GUI.

10. The server of claim 9, wherein the computer-executable instructions, when executed by the processor, cause the processor to dynamically adapt the second templatized image responsive to a user-initiated change in a position of the text within the first templatized image.

11. The server of claim 9, wherein the computer-executable instructions, when executed by the processor, cause the processor to:
automatically generate multiple additional templatized images with improved text legibility based on the first templatized image; and
cause surfacing of the additional templatized images within a design idea window of the graphic design GUI.

12. The server of claim 9, wherein the computer-executable instructions, when executed by the processor, cause the processor to assign the legibility score to the text within the first templatized image by calculating a contrast ratio between a text color of the text and a background color of the first templatized image.

13. The server of claim 9, wherein the computer-executable instructions, when executed by the processor, cause the processor to generate the bounding box around the text area of the first templatized image by:
calculating coordinates of the first templatized image that mark outer edges of the text; and
utilizing the coordinates to generate the bounding box with a predetermined degree of offset from the outer edges of the text.

14. The server of claim 9, wherein the computer-executable instructions, when executed by the processor, cause the processor to perform the selective blurring such that a resulting blurred portion of the second templatized image blends into surrounding colors within the second templatized image.

15. The server of claim 9, wherein the computer-executable instructions, when executed by the processor, cause the processor to cause surfacing of the second templatized image within a design idea window of the graphic design GUI.

16. The server of claim 9, wherein the computer-executable instructions, when executed by the processor, cause the processor to cause surfacing of the second templatized image within a design editing window of the graphic design GUI.

17. A computer-readable storage medium comprising computer-executable instructions that, when executed by a processor, cause the processor to:
cause execution of a graphics application;
cause surfacing of a graphic design graphical user interface (GUI) on a display during the execution of the graphics application;
responsive to a user-initiated insertion of a desired image into a design template surfaced via the graphic design GUI, generate a first templatized image comprising text;
assign a legibility score to the text within the first templatized image;
responsive to a determination that the legibility score is less than a predetermined threshold, generate a bounding box around a text area of the first templatized image;
generate a second templatized image with improved text legibility by selectively blurring a portion of the first templatized image that falls within the bounding box; and
cause surfacing of the second templatized image via the graphic design GUI.

18. The computer-readable storage medium of claim 17, wherein the computer-executable instructions, when executed by the processor, cause the processor to dynamically adapt the second templatized image responsive to a user-initiated change in a position of the text within the first templatized image.

19. The computer-readable storage medium of claim 17, wherein the computer-executable instructions, when executed by the processor, cause the processor to:
automatically generate multiple additional templatized images with improved text legibility based on the first templatized image; and
cause surfacing of the additional templatized images within a design idea window of the graphic design GUI.

20. The computer-readable storage medium of claim 17, wherein the computer-executable instructions, when executed by the processor, cause the processor to assign the legibility score to the text within the first templatized image by calculating a contrast ratio between a text color of the text and a background color of the first templatized image.
